(19) United States
(12) Patent Application Publication
(10) Pub. No.: US 2023/0269719 A1
(43) Pub. Date: Aug. 24, 2023

(54) TECHNIQUES TO FACILITATE UE INDICATION OF SPS PUCCH HARQ FEEDBACK LOCATION

(71) Applicant: QUALCOMM Incorporated, San Diego, CA (US)

(72) Inventors: Konstantinos DIMOU, New York, NY (US); Yan ZHOU, San Diego, CA (US); Tao LUO, San Diego, CA (US); Xiaoxia ZHANG, San Diego, CA (US); Jing SUN, San Diego, CA (US); Yi HUANG, San Diego, CA (US); Ozcan OZTURK, San Diego, CA (US); Peter GAAL, San Diego, CA (US)

(21) Appl. No.: 18/014,068

(22) PCT Filed: Aug. 3, 2021
(86) PCT No.: PCT/US2021/044407

§ 371 Date: Dec. 30, 2022

(30) Foreign Application Priority Data
Aug. 28, 2020 (GR) 20200100522

(51) Int. Cl. H04W 72/11; H04W 72/21; H04W 72/541; H04W 72/1273; H04L 1/1812

(52) U.S. Cl. CPC H04W 72/11; H04W 72/21; H04W 72/541; H04W 72/1273; H04L 1/1812

(57) ABSTRACT

Apparatus, methods, and computer-readable media for facilitating UE indication of SPS PUCCH HARQ feedback location are disclosed herein. An example method for wireless communication at a UE includes monitoring channel variations for SPS signaling associated with multiple SPS configurations. The example method also includes indicating a feedback occasion for providing SPS PUCCH feedback to a base station for at least one SPS configuration of the multiple SPS configurations, the feedback occasion located within a subsequent cycle.

### CROSS REFERENCE TO RELATED APPLICATION(S)

This application claims the benefit of and priority to Greek Patent Application Serial No. 20200100522, entitled “METHODS AND APPARATUS TO FACILITATE UE INDICATION OF SPS PUCCH HARQ FEEDBACK LOCATION,” and filed on Aug. 28, 2020, which is expressly incorporated by reference herein in its entirety.

### TECHNICAL FIELD

The present disclosure relates generally to communication systems, and more particularly, to wireless communications utilizing semi-persistent scheduling (SPS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). An example apparatus monitors channel variations for semi-persistent scheduling (SPS) signaling associated with multiple SPS configurations. The example apparatus also indicates a feedback occasion for providing SPS physical uplink control channel (PUCCH) feedback to a base station for at least one SPS configuration of the multiple SPS configurations, the feedback occasion located within a subsequent cycle.

In another aspect of the disclosure, a method, a computer-readable medium, and an apparatus are provided for wireless communication at a base station. An example apparatus configures multiple SPS configurations at a UE. The example apparatus also receives, from the UE, an indication of a feedback occasion for receiving SPS PUCCH feedback for at least one SPS configuration of the multiple SPS configurations, the feedback occasion located within a subsequent cycle.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and a UE in an access network.

FIG. 4 illustrates an example communication between a base station and a UE, in accordance with various aspects of the present disclosure.

FIG. 5 illustrates an example communication between a base station and a UE, in accordance with various aspects of the present disclosure.

FIG. 6 illustrates an example communication between a base station and a UE, in accordance with various aspects of the present disclosure.

FIG. 7 is an example communication flow between a base station and a UE, in accordance with the teachings disclosed herein.

FIG. 8 is a flowchart of a method of wireless communication at a UE, in accordance with the teachings disclosed herein.

FIG. 9 is a flowchart of a method of wireless communication at a UE, in accordance with the teachings disclosed herein.

FIG. 10 is a diagram illustrating an example of a hardware implementation for an example apparatus, in accordance with the teachings disclosed herein.

FIG. 11 is a flowchart of a method of wireless communication at a base station, in accordance with the teachings disclosed herein.

FIG. 12 is a flowchart of a method of wireless communication at a base station, in accordance with the teachings disclosed herein.

FIG. 13 is a diagram illustrating an example of a hardware implementation for an example apparatus, in accordance with the teachings disclosed herein.

### DETAILED DESCRIPTION

In wireless communication systems, an SPS configuration may be provided for scheduling SPS physical downlink shared channel (PDSCH) transmissions between a UE and a base station. The base station may transmit an SPS PDSCH to the UE using semi-static or periodic resources. The UE may transmit hybrid automatic repeat request (HARQ) feedback indicating an acknowledgement of reception (ACK) to the base station after receiving the SPS PDSCH. In some examples, the UE may transmit HARQ feedback indicating a non-acknowledgement (NACK) to the base station an inability to process the SPS PDSCH, for example, due to a failure to receive the SPS PDSCH, due to a decoding error, etc. In some examples, the base station may configure the UE with multiple SPS configurations. For example, the base station may configure the UE with two or more SPS configurations that each provide resources for traffic (e.g., single traffic). However, resources may be wasted (e.g., due to power usage, due to an inefficient use of radio resources, etc.) when the UE provides HARQ feedback for each SPS associated with the multiple SPS configurations.

Example techniques presented herein enable a wireless communication device, such as a UE, to indicate a single location of SPS PUCCH feedback for multiple SPS configurations. For example, techniques disclosed herein enable the UE to monitor downlink interference for a plurality of downlink transmissions and detect a repetitive downlink interference pattern. The UE may then select an occasion in a subsequent cycle during which to provide the SPS PUCCH feedback based on the detected repetitive downlink interference pattern. In some examples, the UE may detect a non-regular traffic pattern (e.g., due to bursts of traffic) and select an occasion in a subsequent cycle during which to provide the SPS PUCCH feedback based on the detected non-regular traffic pattern. The UE may then provide the respective SPS PUCCH feedback at the corresponding occasion.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

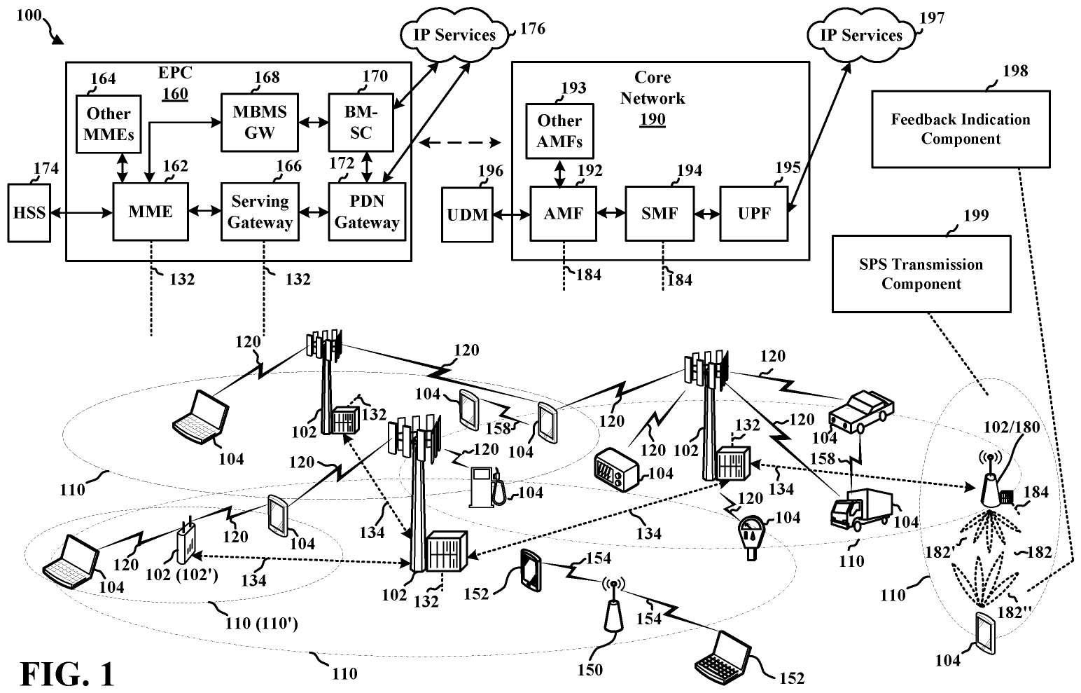

FIG. 1 is a diagram illustrating an example of a wireless communications system and an access network 100 including base stations 102 and 180 and UEs 104. In certain aspects, a device in communication with a base station, such as a UE 104, may be configured to manage one or more aspects of wireless communication by indicating an occasion for providing SPS PUCCH feedback when multiple SPS configurations are configured. As an example, in FIG. 1, the UE 104 may include a feedback indication component 198 configured to monitor channel variations for SPS signaling associated with multiple SPS configurations. The example feedback indication component 198 may also be configured to indicate a feedback occasion for providing SPS PUCCH feedback to a base station for at least one SPS configuration of the multiple SPS configurations, the feedback occasion located within a subsequent cycle.

In another configuration, a base station, such as the base stations 102/180, may be configured to manage or more aspects of wireless communication by configuring multiple SPS configurations for a UE and enabling the UE to indicate an SPS PUCCH feedback location. As an example, in FIG. 1, the base station 102/180 may include SPS transmission component 199 configured to configure multiple SPS configurations at a UE. The example SPS transmission component 199 may also be configured to receive, from the UE, an indication of a feedback occasion for receiving SPS PUCCH feedback for at least one SPS configuration of the multiple SPS configurations, the feedback occasion located within a subsequent cycle.

The aspects presented herein may enable a UE to indicate feedback occasions for providing HARQ feedback, which may facilitate improving communication performance, for example, by reducing uplink overhead.

Although the following description provides examples directed to 5G NR (and, in particular, to transmissions associated with SPS traffic), the concepts described herein may be applicable to other similar areas, such as LTE, LTE-A, CDMA, GSM, and/or other wireless technologies, in which a UE may select an occasion for providing SPS feedback based on, for example, channel variations and/or non-regular traffic patterns.

The example of the wireless communications system of FIG. 1 (also referred to as a wireless wide area network (WWAN)) includes the base stations 102, the UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

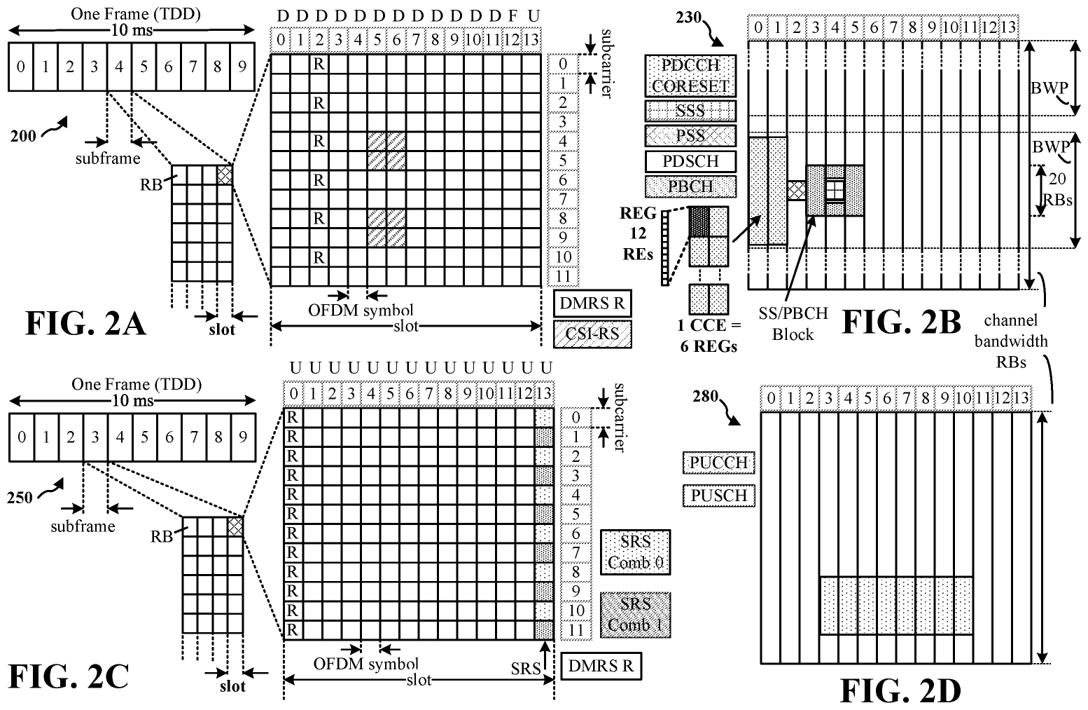

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARD) acknowledgment (ACK) (HARQ-ACK) information (ACK/negative ACK (NACK)) feedback. The PUSCH carries data, and may additionally be used to carry a buffer status report (BSR), a power headroom report (PHR), and/or UCI.

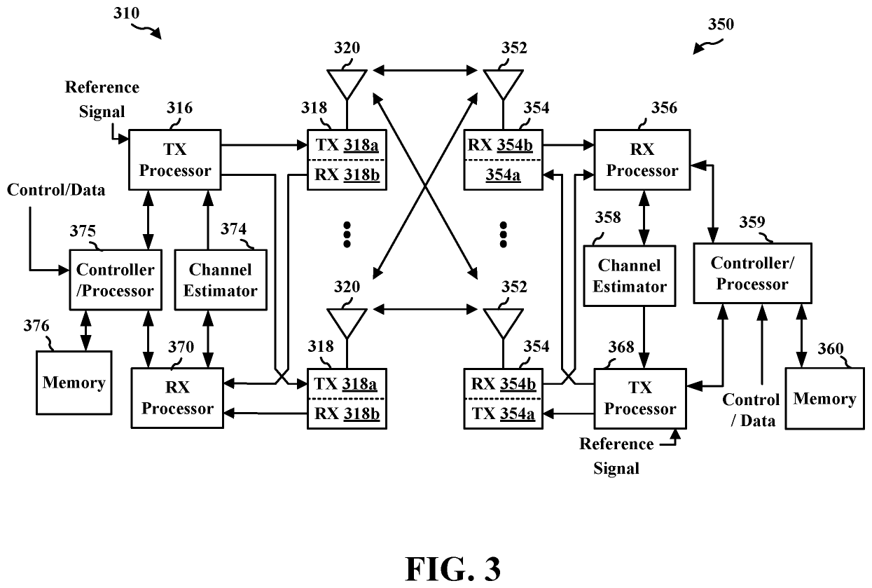

FIG. 3 is a block diagram that illustrates an example of a first wireless device that is configured to exchange wireless communication with a second wireless device. In the illustrated example, the first wireless device may include a base station 310, the second wireless device may include a UE 350, and the base station 310 may be in communication with the UE 350 in an access network. As shown in FIG. 3, the base station 310 includes a transmit processor (TX processor 316), a transceiver 318 including a transmitter 318a and a receiver 318b, antennas 320, a receive processor (RX processor 370), a channel estimator 374, a controller/processor 375, and memory 376. The example UE 350 includes antennas 352, a transceiver 354 including a transmitter 354a and a receiver 354b, an RX processor 356, a channel estimator 358, a controller/processor 359, memory 360, and a TX processor 368. In other examples, the base station 310 and/or the UE 350 may include additional or alternative components.

In the DL, IP packets from the EPC 160 may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318a. Each transmitter 318a may modulate a radio frequency (RF) carrier with a respective spatial stream for transmission.

At the UE 350, each receiver 354b receives a signal through its respective antenna 352. Each receiver 354b recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354a. Each transmitter 354a may modulate an RF carrier with a respective spatial stream for transmission.

The UL transmission is processed at the base station 310 in a manner similar to that described in connection with the receiver function at the UE 350. Each receiver 318b receives a signal through its respective antenna 320. Each receiver 318b recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the feedback indication component 198 of FIG. 1.

At least one of the TX processor 316, the RX processor 370, and the controller/processor 375 may be configured to perform aspects in connection with the SPS transmission component 199 of FIG. 1.

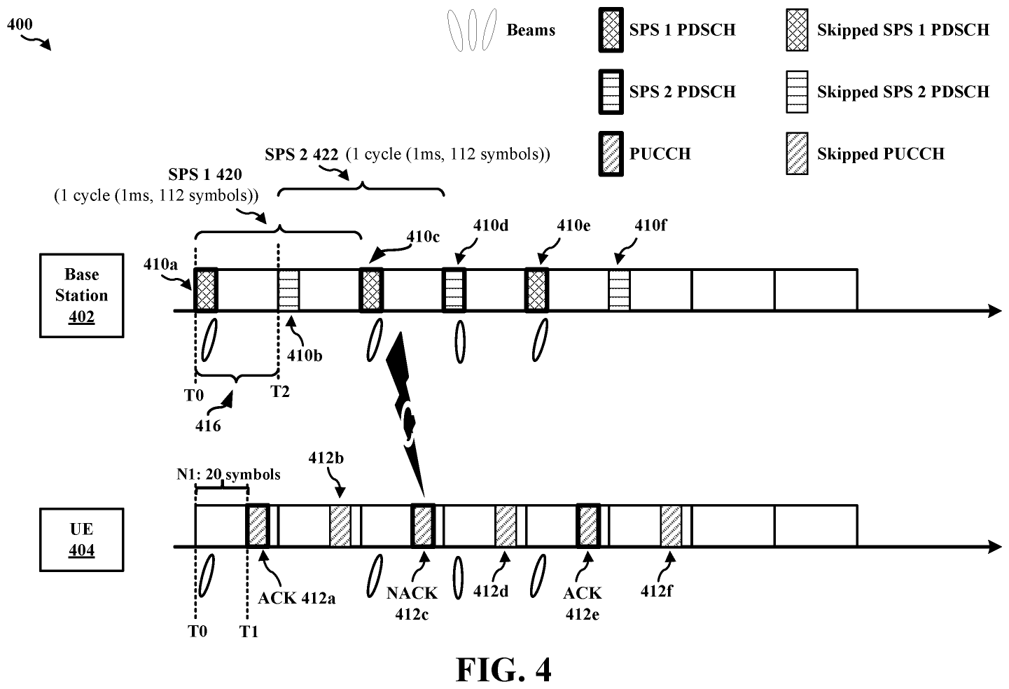

In wireless communication systems, an SPS configuration may be provided for scheduling SPS PDSCH transmissions between a UE and a base station. An SPS configuration may include a periodicity, SPS-assigned downlink resources when downlink data is available for transmission, and/or SPS-assigned uplink resources when uplink data is available for transmission. FIG. 4 illustrates an example communication 400 including a base station 402 and a UE 404. Aspects of the base station 402 may be implemented by the base station 102/180 of FIG. 1 and/or the base station 310 of FIG. 3. Aspects of the UE 404 may be implemented by the UE 104 of FIG. 1 and/or the UE 350 of FIG. 3.

In the illustrated example of FIG. 4, the base station 402 may transmit a first SPS PDSCH 410a that is received by the UE 404. The base station 402 may transmit the first SPS PDSCH 410a using semi-static resources or periodic resources. The UE 404 may transmit HARQ feedback to the base station 402 indicating an acknowledgement (ACK) of reception or a non-acknowledgement (NACK) of reception associated with the SPS PDSCH 410a. In the illustrated example, the HARQ feedback includes ACK feedback 412a indicating that the UE 404 successfully received the first SPS PDSCH 410a. In some examples, the UE 404 may transmit NACK feedback to the base station 402 when processing of the first SPS PDSCH 410a is unsuccessful (e.g., due to a failure to receive the SPS PDSCH 410a, due to inability to decode the SPS PDSCH 410a, etc.). As shown in FIG. 4, there may be an N1 offset between the start of a cycle (e.g., at a time TO) and when the UE 404 transmits the HARQ feedback (e.g. at a time T1). In the illustrated example, the duration of the N1 offset is 20 symbols. However, other examples may use additional or alternative durations.

In some examples, the base station 402 may configure the UE 404 with multiple SPS configurations. For example, the base station 402 may configure the UE 404 with two or more SPS configurations that each provide resources for traffic (e.g., single traffic). As used herein, the term “single traffic” may refer to a single source of packets. As an example, the single traffic may be from a sensor transmitting one packet of a 40 bytes every 8.3 msec. This single traffic, e.g., from the single source, can be mapped to one or more channels. Providing multiple SPS configurations for single traffic may improve the reliability of a packet successfully being transmitted. In the illustrated example of FIG. 4, the base station 402 may configure a first SPS configuration 420 (“SPS 1”) and a second SPS configuration 422 (“SPS 2”). As shown in FIG. 4, each of the SPS configurations 420, 422 are associated with one cycle including one millisecond (ms) or 112 symbols.

In some examples, the base station 402 may configure the different SPS configurations 420, 422 so that each SPS configuration is offset by respective durations from a previous SPS configuration. As shown in FIG. 4, a duration 416 may be defined by the start of the first SPS configuration 420 (e.g., at the time TO) and the start of the second SPS configuration 422 (e.g., at a time T2). For example, the base station 402 may configure the SPS configurations and offset the second SPS configuration 422 to start half a millisecond after the start of the first SPS configuration 420. In some examples, the second SPS configuration 422 may provide retransmissions of the same packet as the first SPS configuration 420. In some such examples, each corresponding cycle of the respective SPS configuration may provide transmissions (or retransmissions) of a same packet. Accordingly, the corresponding cycles of the respective SPS configurations may be generally referred to herein as “packet cycles.” For example, a first packet cycle may include a first cycle of the first SPS configuration 420 and a corresponding first cycle of the second SPS configuration 422. The first packet cycle may also provide transmissions (or retransmissions) of a first packet. Similarly, a second packet cycle may include a second cycle of the first SPS configuration 420 and a corresponding second cycle of the second SPS configuration 422. The second packet cycle may also provide transmissions (or retransmissions) of a second packet, etc.

The base station 402 may skip a subsequent SPS PDSCH for a variety of reasons. For example, the base station 402 may skip an SPS PDSCH to free up resources for another transmission that is determined to be of higher priority for the base station 402. In some examples, the base station 402 may skip an SPS PDSCH after receiving an ACK feedback from the UE 404. For example, the base station 402 may skip a second SPS PDSCH 410b after receiving the ACK feedback 412a indicating that the UE 404 successfully received the first SPS PDSCH 410a. As shown in FIG. 4, the first SPS PDSCH 410a may correspond to the first SPS configuration 420 and the second SPS PDSCH 410b may correspond to the second SPS configuration 422.

In some examples, an SPS configuration may not configure uplink feedback. For example, the second SPS configuration 422 may not provide feedback occasions for the UE 404 to provide HARQ feedback, such as occasions for HARQ feedback 412b, 412d, 412f. For example, HARQ feedback transmitted by the UE 404 during a HARQ feedback occasion associated with the second SPS configuration 422 may occur after the expiration of a timer (e.g., a HARQ round trip time (RTT) timer). The use of the timer may allow the base station 402 to discard feedback that is of limited use or no use due to, for example, packet expiration. For example, if the UE 404 transmits HARQ feedback 412b, the base station 402 may not receive the HARQ feedback 412b in time for retransmission of an unsuccessful transmission before a new packet is scheduled for transmission (e.g., a new packet associated with a second, subsequent packet cycle).

In some examples, a downlink transmission/reception beam used for transmission between the base station 402 and the UE 404 may be blocked due to a variety of reasons, such as UE movement, interference, channel condition change, or the like. As shown in FIG. 4, the base station 402 may attempt to transmit a third SPS PDSCH 410c, but the UE 404 may be unable to receive the third SPS PDSCH 410c due to beam blocking. The UE 404 may transmit NACK feedback 412c indicating that the UE 404 unsuccessfully received the third SPS PDSCH 410c. After receiving the NACK feedback 412c, the base station 402 may retransmit the packet of the third PDSCH 410c using a fourth SPS PDSCH 410d. While the UE 404 may successfully receive the fourth SPS PDSCH 410d, the UE 404 may not be configured to provide HARQ feedback 412d due to, for example, concerns related to packet expiration discussed above.

The base station 402 may then transmit a fifth SPS PDSCH 410e that is received by the UE 404. The fifth SPS PDSCH 410e may be associated with a third packet cycle. The UE 404 may transmit ACK feedback 412e indicating an acknowledgement of reception of the fifth SPS PDSCH 410e to the base station 402. The base station 402 may skip a subsequent sixth SPS PDSCH 410f after receiving the ACK feedback 412e. The sixth SPS PDSCH 410f may also be associated with the third packet cycle.

As shown in FIG. 4, the example communication 400 between the base station 402 and the UE 404 enables reducing uplink overhead when the UE 404 is configured with multiple SPS configurations. For example, instead of providing HARQ feedback for each SPS PDSCH (e.g., the first SPS PDSCH 410a, the third SPS PDSCH 410c, and the fifth SPS PDSCH 410e associated with the first SPS configuration 420 and/or the second SPS PDSCH 410b, the fourth SPS PDSCH 410d, and the sixth SPS PDSCH 410f associated with the second SPS configuration 422), the UE 404 may be configured to provide HARQ feedback during feedback occasions associated with the first SPS configuration 420. Such a configuration may enable the UE 404 to conserve power and resources by foregoing transmitting HARQ feedback with respect to the second SPS configuration 422. Such a configuration may avoid the UE 404 transmitting HARQ feedback to the base station 402 that is not usable by the base station 402. Additionally, the example configuration of FIG. 4 may reduce ambiguity at the UE 404 with respect to deciding whether the base station 402 transmitted an SPS PDSCH. For example, based on the transmission of ACK feedback, the UE 404 may determine that the base station 402 is foregoing the transmission of subsequent SPS PDSCHs associated with the same packet cycle. In some examples, the UE 404 may transmit a discontinuous transmission (DTX) to the base station 402 and skip providing HARQ feedback. Transmitting DTX may consume less power and radio resources compared to transmitting HARQ feedback.

In some examples, the base station 402 may communicate non-regular traffic with the UE 404. For example, in an extended reality (XR) ecosystem combining aspects of augmented reality (AR), virtual reality (VR), and/or artificial intelligence (AI), traffic may be communicated between the base station 402 and the UE 404 in bursts.

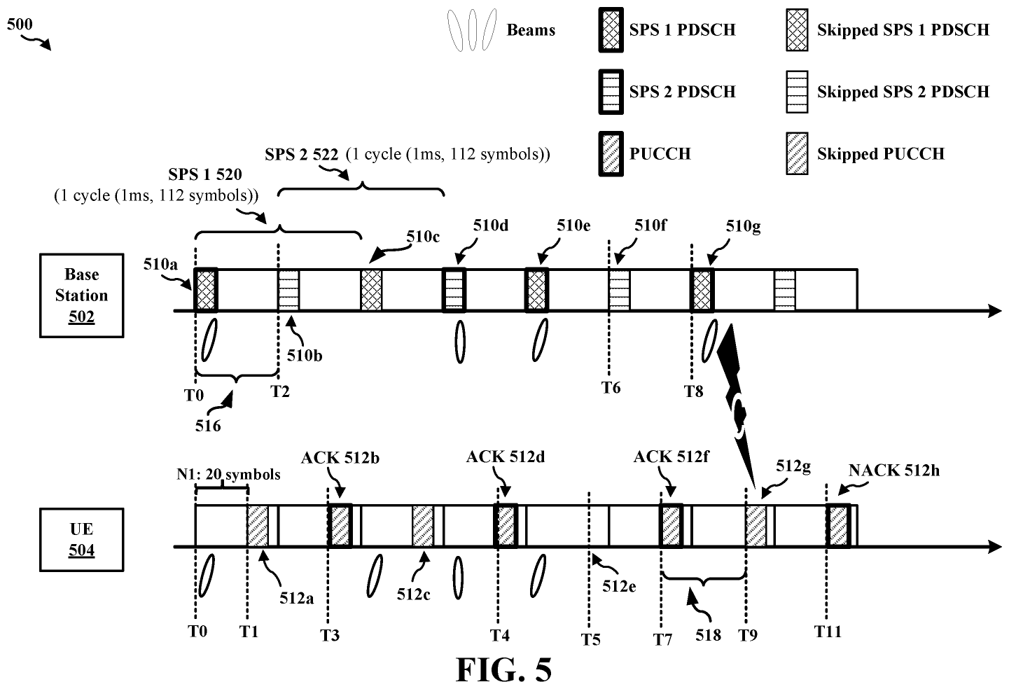

FIG. 5 illustrates another example communication 500 including a base station 502 and a UE 504. Aspects of the base station 502 may be implemented by the base station 102/180 of FIG. 1, the base station 310 of FIG. 3, and/or the base station 402 of FIG. 4. Aspects of the UE 504 may be implemented by the UE 104 of FIG. 1, the UE 350 of FIG. 3, and/or the UE 404 of FIG. 4.

Similar to the example of FIG. 4, the communication 500 includes two SPS configurations (e.g., a first SPS configuration 520 (“SPS 1”) and a second SPS configuration 522 (“SPS 2”)). However, other examples may include any suitable quantity of SPS configurations. In the illustrated example of FIG. 5, the second SPS configuration 522 is offset from the first SPS configuration 520 by a duration 516, which may be any suitable interval, such as 50 microseconds, 100 microseconds, one-half millisecond, etc. In the illustrated example, the UE 504 may also be configured to provide HARQ feedback once per millisecond.

In the illustrated example of FIG. 5, the base station 502 may transmit a first SPS PDSCH 510a to the UE 504 using semi-static or periodic resources. As shown in FIG. 5, the first SPS PDSCH 510a may be associated with the first SPS configuration 520. The UE 504 may transmit ACK feedback 512b to the base station 502 indicating successful receipt of the first SPS PDSCH 510a. As shown in FIG. 5, the UE 504 may not be configured to provide HARQ feedback during a HARQ feedback occasion 512a and, thus, may wait to transmit the ACK feedback 512b. In some examples, the ACK feedback 512b may correspond to the SPS PDSCHs associated with the respective packet cycle. For example, the UE 504 may provide the ACK feedback 512b with respect to a first cycle of the first SPS configuration 520 and a corresponding first cycle of the second SPS configuration 522.

In the illustrated example of FIG. 5, there may be transmit occasions associated with the SPS configurations during which the base station 502 may not be scheduled to transmit packets to the UE 504. For example, the base station 502 may skip transmitting a second SPS PDSCH 510b and a third SPS PDSCH 510c, for example, due to a determination that there are no packets for transmission. Accordingly, the UE 504 skips transmitting HARQ feedback 512c.

In the illustrated example, the base station 502 transmits a fourth SPS PDSCH 510d that is received by the UE 504. The UE 504 may transmit ACK feedback 512d to the base station 502 indicating successful receipt of the fourth SPS PDSCH 510d. In some examples, the feedback occasion associated with the ACK feedback 512d may satisfy the one HARQ feedback per millisecond configuration of the UE 504 (e.g., the ACK feedback 512b at a time T3 and the ACK feedback 512d at a time T4 are separated by at least one millisecond).

The base station 502 may transmit a fifth SPS PDSCH 510e that is received by the UE 504. The UE 504 may skip providing HARQ feedback 512e associated with the fifth SPS PDSCH 510e (e.g., at a time T5) and may wait to transmit ACK feedback 512f to the base station 502 (e.g., at a time T7) indicating successful receipt of the fifth SPS PDSCH 510e. Similar to the ACK feedback 512b at time T3 corresponding to the SPS PDSCHs associated with a same packet cycle (e.g., the first packet cycle), the ACK feedback 512f at the time T7 may correspond to the SPS PDSCHs associated with a third packet cycle. For example, the UE 504 may provide the ACK feedback 512f for a third cycle of the first SPS configuration 520 and a corresponding third cycle of the second SPS configuration 522.

As shown in FIG. 5, the base station 502 may skip transmitting a sixth SPS PDSCH 510f. For example, the base station 502 may skip the sixth SPS PDSCH 510f due to, for example, a determination that there are no packets for transmission at the corresponding transmit occasion (e.g., at time T6).

The base station 502 may attempt to transmit a seventh SPS PDSCH 510g at a time T8. However, the UE 504 may be unable to receive the seventh SPS PDSCH 510g due to, for example, beam blocking. The UE 504 may additionally be unable to transmit NACK feedback to the base station 502 (e.g., at a feedback occasion 512g) indicating unsuccessful receipt of the seventh SPS PDSCH 510g. For example, the UE 504 may be unable to transmit the NACK feedback due to the configuration limiting the UE 504 to one HARQ feedback per one millisecond. For example, a duration 518 between the time T7 associated with the ACK feedback 512f and a time T8 associated with the feedback occasion 512g may be less than one millisecond. In such examples, the UE 504 may then wait to transmit NACK feedback 512h to the base station 502 at a time T10. However, as discussed above, the NACK feedback 512h may arrive too late at the base station 502 for the base station 502 to retransmit the unsuccessful transmission before a new packet is scheduled for transmission (e.g., a new packet associated with a fifth packet cycle).

As shown in FIG. 5, the example communication 500 between the base station 502 and the UE 504 enables reducing uplink overhead when the UE 504 is configured with multiple SPS configurations. For example, the UE 504 may provide a HARQ feedback (e.g., the ACK feedback 512b at time T3) with respect to two SPS configurations. Such a feedback configuration enables the UE 504 to conserve power and resources by avoiding transmitting HARQ feedback for every received SPS PDSCH. Additionally, the example feedback configuration of FIG. 5 may reduce ambiguity at the UE 504 with respect to whether the base station 502 transmitted an SPS PDSCH. For example, based on the transmission of ACK feedback, the UE 504 may determine that the base station 502 is foregoing the transmission of subsequent SPS PDSCHs associated with the same packet cycle.

In some examples, the UE 504 may transmit a discontinuous transmission (DTX) to the base station 502 and skip providing HARQ feedback. Transmitting DTX may consume less power and radio resources compared to transmitting HARQ feedback. However, as shown in FIG. 5, in some examples, the UE 504 may be prevented from providing HARQ feedback in a reasonable timeframe to allow the base station 502 to retransmit an unsuccessful transmission. For example, because the UE 504 is unable to provide HARQ feedback at the feedback occasion 512g at the time T9, the NACK feedback 512h may be received by the base station 502 with not enough time to process the received feedback and to transmit a retransmission.

To mitigate the issue of unnecessary uplink transmission, examples disclosed herein enable the UE to indicate a location at which the UE is providing HARQ feedback. For example, the UE may be configured with multiple SPS configurations. The UE may detect a pattern related to downlink communications associated with the multiple SPS configurations. In some examples, the pattern may include a repetitive pattern of downlink interference. In some examples, the pattern may include a non-regular traffic pattern (e.g., due to bursts of traffic communication). The UE may use the detected pattern to select a feedback occasion to provide HARQ feedback. In some examples, the selected feedback occasion may be located within a subsequent packet cycle.

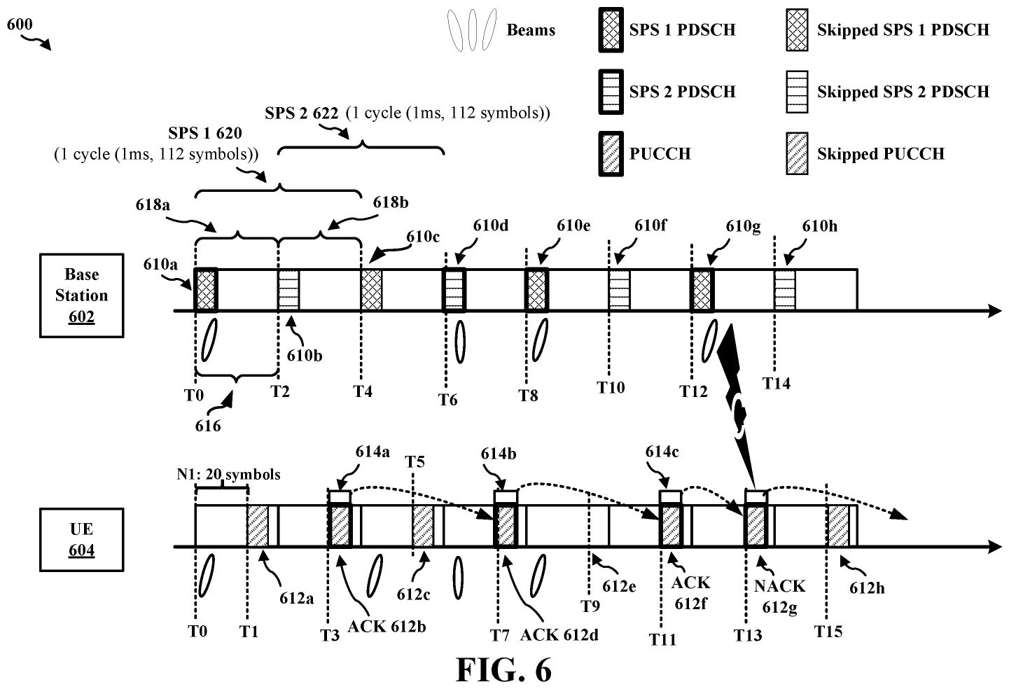

FIG. 6 illustrates an example communication 600 including a base station 602 and a UE 604, as presented herein. Aspects of the base station 602 may be implemented by the base station 102/180 of FIG. 1, the base station 310 of FIG. 3, the base station 402 of FIG. 4, and/or the base station 502 of FIG. 5. Aspects of the UE 604 may be implemented by the UE 104 of FIG. 1, the UE 350 of FIG. 3, the UE 404 of FIG. 4, and/or the UE 504 of FIG. 5.

In the illustrated example of FIG. 6, the UE 604 is configured with two SPS configurations for a packet cycle (e.g., a first SPS configuration 620 (“SPS 1”) and a second SPS configuration 622 (“SPS 2”)). However, other examples may employ any suitable quantity of SPS configurations for a packet cycle. In the illustrated example, the second SPS configuration 522 is offset from the first SPS configuration 520 by a duration 616, which may be any suitable interval, such as 50 microseconds, 100 microseconds, one-half millisecond, etc. Similar to the example of FIG. 6, the UE 604 may be configured to provide a single HARQ feedback for the SPS configurations of a same packet cycle, thereby reducing uplink overhead.

As shown in FIG. 6, the base station 602 transmits a first SPS PDSCH 610a at a time T0 that is received by the UE 604. In the illustrated example, the UE 604 is not configured to transmit HARQ feedback at a feedback occasion 612a (e.g., at a time T1) and waits to transmit ACK feedback 612b (e.g., at a time T3) to the base station 602 indicating successful receipt of the first SPS PDSCH 610a. In the example of FIG. 6, the base station 602 skips transmitting a second SPS PDSCH 610b (e.g., at a time T2) and also skips transmitting a third SPS PDSCH 610c (e.g., at a time T4). The base station 602 may skip transmitting the second SPS PDSCH 610b and the third SPS PDSCH 610c for a variety of reasons, such as to free up resources, due to known interference (e.g., collisions with other resources), etc.

In the illustrated example of FIG. 6, when the UE 604 transmits the ACK feedback 612b at the time T3, the UE 604 also transmits a first indication 614a. The first indication 614a may indicate a feedback occasion at which the UE 604 is going to provide subsequent HARQ feedback. For example, the first indication 614a may indicate which of the feedback occasions associated with a second packet cycle (e.g., feedback occasions at time T5 and at time T7) that the UE 604 is going to provide the corresponding HARQ feedback. As shown in FIG. 6, the first indication 614a indicates the feedback occasion at time T7 for providing HARQ feedback for the SPS PDSCHs associated with the second packet cycle. The UE 604 may skip transmitting HARQ feedback 612c at the time T5.

The base station 602 transmits a fourth SPS PDSCH 610d at a time T6 that is received by the UE 604. As indicated by the first indication 614a, the UE 604 transmits HARQ feedback associated with the second packet cycle at the time T7. For example, the UE 604 may transmit ACK feedback 612d to the base station 602 at the time T7 to indicate successful receipt of the fourth SPS PDSCH 610d. The UE 604 also includes a second indication 614b with the ACK feedback 612d at the time T7. The example second indication 614b indicates a feedback occasion for a subsequent packet cycle (e.g., feedback occasions at time T9 and at time T11) during which the UE 604 is going to provide the corresponding HARQ feedback. As shown in FIG. 6, the second indication 614b indicates the feedback occasion at the time T11 for providing HARQ feedback for the SPS PDSCHs associated with the third packet cycle. The UE 604 may skip transmitting HARQ feedback 612e at the time T9.

The base station 602 transmits a fifth SPS PDSCH 610e at time T8 that is received by the UE 604. As indicated by the second indication 614b, the UE 604 transmits HARQ feedback at the time T11 with respect to the SPS PDSCHs associated with the third packet cycle. For example, the UE 604 transmits ACK feedback 612f to the base station 602 at the time T11 to indicate successful receipt of the fifth SPS PDSCH 610e during the third packet cycle. The UE 604 also includes a third indication 614c with the ACK feedback 612f at the time T11. The example third indication 614c indicates a feedback occasion for a subsequent packet cycle (e.g., feedback occasions at a time T13 and at a time T15) during which the UE 604 is going to provide HARQ feedback. As shown in FIG. 6, the third indication 614c indicates the feedback occasion at the time T13 for providing HARQ feedback for the SPS PDSCHs associated with the next packet cycle. The UE 604 may skip transmitting HARQ feedback 612h at the time T15.

The base station 602 may skip transmitting a sixth SPS PDSCH 610f at a time T10 due to a variety of reasons, as described above. The base station 602 may attempt to transmit a seventh SPS PDSCH 610g at a time T12, but the UE 604 may be unable to receive the seventh SPS PDSCH 610g, for example, due to beam blocking. As indicated by the third indication 614c, the UE 604 transmits HARQ feedback to the base station 602 at the time T13 with respect to the SPS PDSCHs associated with the fourth packet cycle. For example, the UE 604 may transmit NACK feedback 612g to the base station 602 at the time T13 to indicate unsuccessful receipt of the seventh SPS PDSCH 610g. The UE 604 may also provide an indication for a feedback occasion associated with a subsequent packet cycle at which the UE 604 is going to provide HARQ feedback for the respective packet cycle.

After receiving the NACK feedback 612g, the base station 602 may transmit an eighth SPS PDSCH 610h at a time T14 that is received by the UE 604.

In some examples, the UE 604 may select the feedback occasion for providing subsequent HARQ feedback based on a detected pattern. For example, the UE 604 may monitor interference associated with downlink transmissions and select a feedback occasion based on a detected repetitive downlink interference pattern. For example, the UE 604 may determine, based on past communications, that there is high interference at the feedback occasion at the time T15. In some such examples, the UE 604 may select the feedback occasion at the time T13 to provide the HARQ feedback for the respective packet cycle. In some examples, the UE 604 may detect the repetitive downlink interference pattern based on measurements of received CSI-RS and/or received PDSCH.

In some examples, the UE 604 may detect non-regular traffic patterns based on past communications. For example, the UE 604 may detect bursts of traffic, as described in connection with the communication 500 of FIG. 5. In some such examples, the UE 604 may select feedback occasions for subsequent packet cycles based on the detected bursts of traffic. However, in some such examples, the base station 602 may additionally detect the burst of traffic and may make adjustments on the network-side. For example, the base station 602 may adjust one or more of the SPS configurations 620, 622 configured for the UE 604.

In some examples, the UE 604 may indicate one or more of the indications 614a, 614b, 614c via one or more bits. In some examples, the number of bits may be based on the number of SPS configurations. For example, when the UE 604 is configured with two SPS configurations, then the UE 604 may use one bit to indicate the feedback occasion associated with the respective SPS configuration. In some examples, the indications 614a, 614b, 614c may indicate a portion of a cycle. For example, each cycle of the first SPS configuration 620 may include a first portion 618a and a second portion 618b. In some such examples, an indication may indicate whether the UE 604 is providing the HARQ feedback in the first portion 618a of the cycle or the second portion 618b of the cycle.

As shown in FIG. 6, the example communication 600 between the base station 602 and the UE 604 enables reducing uplink overhead when the UE 604 is configured with multiple SPS configurations. Additionally, by enabling the UE 604 to indicate feedback occasions for providing respective HARQ feedback, the UE 604 may reduce unnecessary uplink transmissions. For example, by monitoring past communications and detecting a pattern, the UE 604 may select subsequent feedback occasions for providing HARQ feedback that reduce occurrences of transmitting NACK feedback that is unusable by the base station 602. In some examples, the base station 602 may use the indication to schedule reception of the HARQ feedback. In some examples, the base station 602 may use the indication to adjust an SPS configuration.

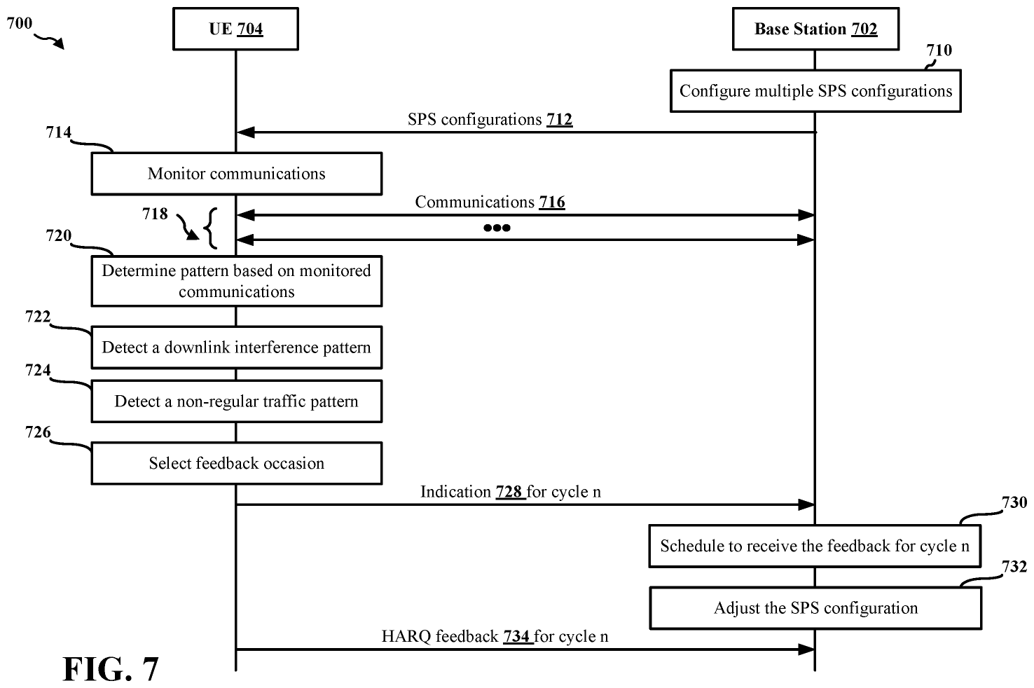

FIG. 7 illustrates an example communication flow 700 between a base station 702 and a UE 704, as presented herein. In the illustrated example, the communication flow 700 facilitates the UE 704 indicating a feedback occasion for a subsequent packet cycle when configured with multiple SPS configurations. Aspects of the base station 702 may be implemented by the base station 102/180 of FIG. 1, the base station 310 of FIG. 3, the base station 402 of FIG. 4, the base station 502 of FIG. 5, and/or the base station 602 of FIG. 6. Aspects of the UE 704 may be implemented by the UE 104 of FIG. 1, the UE 350 of FIG. 3, the UE 404 of FIG. 4, the UE 504 of FIG. 5, and/or the UE 604 of FIG. 6. Although not shown in the illustrated example of FIG. 7, it may be appreciated that in additional or alternative examples, the base station 702 may be in communication with one or more other base stations or UEs, and/or the UE 704 may be in communication with one or more other base stations or UEs.

In the illustrated example of FIG. 7, at 710, the base station 702 configures multiple SPS configurations 712 for the UE 704. For example, the base station 702 may configure the multiple SPS configurations 712 with respective periodicities, respective downlink resources, and/or respective uplink resources. In some examples, the base station 702 may configure the multiple SPS configurations 712 with an offset relative to a previous SPS configuration. For examples, and referring to the example communication 600 of FIG. 6, the base station 602 may configure the start of the second SPS configuration 622 from the start of the first SPS configuration 620 by the duration 616. In some examples, the base station 702 may configure the multiple SPS configurations 712 to reduce jitter in traffic.

As shown in FIG. 7, the base station 702 may transmit the multiple SPS configurations 712 that are received by the UE 704. In some examples, the base station 702 may transmit the multiple SPS configurations 712 using RRC signaling. In some examples, the transmission of the multiple SPS configurations 712 may also activate one or more of the multiple SPS configurations 712 at the UE 704. In some examples, the base station 702 may activate one or more of the multiple SPS configurations 712 using separate signaling, such as DCI and/or a MAC-CE.

At 714, the UE 704 initiates monitoring communications 716. In some examples, the UE 704 may monitor the communications 716 for an interval 718. The communications 716 may include uplink messages and/or downlink messages. In some examples, the communications 716 may include CSI-RS and/or PDSCH. However, it may be appreciated that the communications 716 may include additional or alternative messages.

At 720, the UE 704 may determine a pattern based on the monitored communications 716. For example, at 722, the UE 704 may detect a repetitive downlink interference pattern based on the communications 716. The UE 704 may detect the repetitive downlink interference pattern based on received CSI-RS and/or received PDSCH.

In some examples, the UE 704 may detect, at 724, a non-regular traffic pattern (e.g., bursts of traffic) based on the communications 716.

At 726, the UE 704 selects a feedback occasion to provide HARQ feedback for a subsequent packet cycle. For example, the UE 704 may select a feedback occasion to reduce the occurrence of interference or to provide the base station 702 time to transmit a retransmission when appropriate.

As shown in FIG. 7, the UE 704 may transmit an indication 728 that is received by the base station 702. The indication 728 may indicate a feedback occasion for a subsequent packet cycle n. The UE 704 may also transmit HARQ feedback 734 that is received by the base station 702. The UE 704 may transmit the HARQ feedback 734 at the feedback occasion indicated by the indication 728. In some examples, the UE 704 may transmit the HARQ feedback to the base station via an uplink data channel, such as PUSCH.

In some examples, after receiving the indication 728, the base station 702 may schedule, at 730, reception of the HARQ feedback for the subsequent packet cycle n. For example, and referring to the example communication 600 of FIG. 6, the base station 602 may schedule reception of HARQ feedback at the time T7 for the second packet cycle based on the feedback occasion indicated by the first indication 614a, may schedule reception of HARQ feedback at time T11 for the third packet cycle based on the feedback occasion indicated by the second indication 614b, and may schedule reception of HARQ feedback at the time T13 for the fourth packet cycle based on the feedback occasion indicated by the third indication 614c.

In some examples, after receiving the indication 728, the base station 702 may adjust, at 732, one or more of the SPS configurations. For example, the base station 702 may determine, based on the indication 728, that there is high interference associated with one or more of the multiple SPS configurations 712 and determine to adjust one or more of the periodicity, the offset, the uplink resources, and/or the downlink resources associated with the respective one or more SPS configurations.

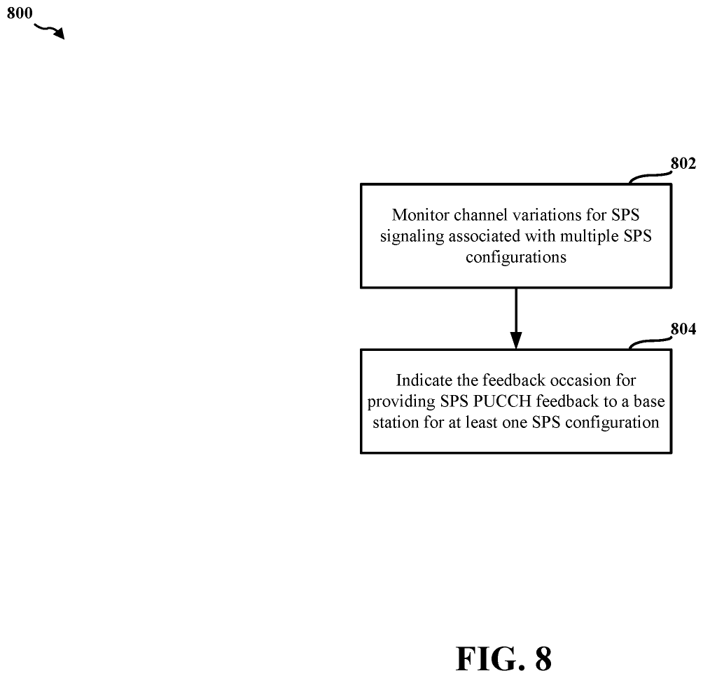

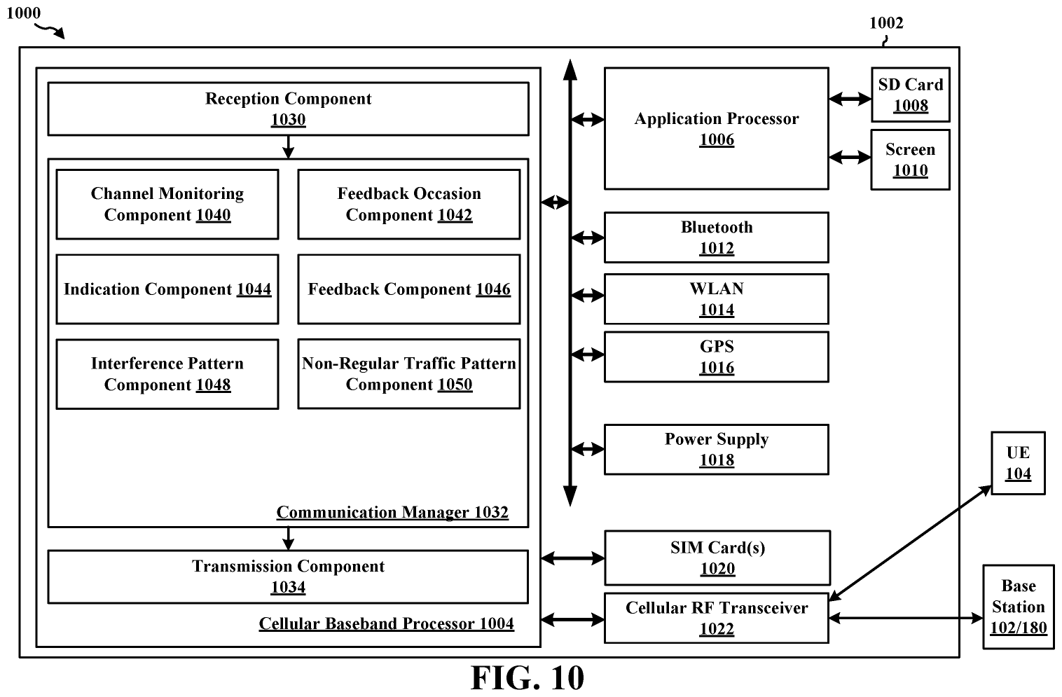

FIG. 8 is a flowchart 800 of a method of wireless communication. The method may be performed by a UE (e.g., the UE 104, the UE 350, and/or an apparatus 1002 of FIG. 10). The method may facilitate reducing uplink overhead and/or reducing UE power consumption by enabling a UE to indicate a location of a single HARQ feedback for multiple SPS configurations.

At 802, the UE monitors channel variations for SPS signaling associated with multiple SPS configurations, as described in connection with 714 and the communications 716 of FIG. 7. The monitoring of the channel variations, at 802, may be performed by a channel monitoring component 1040 of the apparatus 1002 of FIG. 10. In some examples, each SPS configuration of the multiple SPS configurations may be offset from a preceding SPS configuration by a respective duration, such as the example duration 616 of FIG. 6.

At 804, the UE indicates the feedback occasion for providing SPS PUCCH feedback to a base station for at least one SPS configuration of the multiple SPS configurations, the feedback occasion located within a subsequent cycle, as described in connection with the indication 728 of FIG. 7. The indicating of the feedback occasion, at 804, may be performed by an indication component 1044 of the apparatus 1002 of FIG. 10.

In some examples, the UE may provide the indication for the feedback occasion with PUCCH HARQ feedback during a current cycle, as described in connection with the indications 614a, 614b, 614c of FIG. 6.

In some examples, the indication may indicate a portion of a cycle of the at least one SPS configuration. For example, the indication may indicate that the feedback occasion is located during a first portion of a cycle of the at least one SPS configuration (e.g., the first portion 618a of FIG. 6) or a second portion of the cycle of the at least one SPS configuration (e.g., the second portion 618b of FIG. 6).

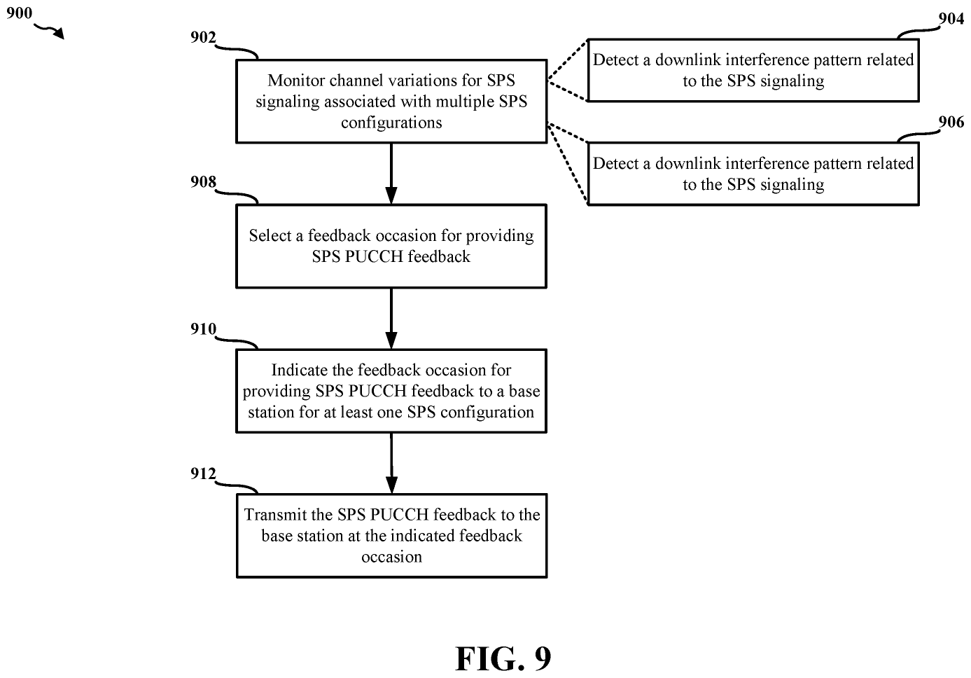

FIG. 9 is a flowchart 900 of a method of wireless communication. The method may be performed by a UE (e.g., the UE 104, the UE 350, and/or an apparatus 1002 of FIG. 10). The method may facilitate reducing uplink overhead and/or reducing UE power consumption by enabling a UE to indicate a location of a single HARQ feedback for multiple SPS configurations.

At 902, the UE monitors channel variations for SPS signaling associated with multiple SPS configurations, as described in connection with 714 and the communications 716 of FIG. 7.

The monitoring of the channel variations, at 902, may be performed by a channel monitoring component 1040 of the apparatus 1002 of FIG. 10. In some examples, each SPS configuration of the multiple SPS configurations may be offset from a preceding SPS configuration by a respective duration, such as the example duration 616 of FIG. 6.

At 908, the UE may select a feedback occasion for providing SPS PUCCH feedback, as described in connection with 726 of FIG. 7. The selecting of the feedback occasion, at 908, may be performed by a feedback occasion component 1042 of the apparatus 1002 of FIG. 10.

At 910, the UE indicates the feedback occasion for providing SPS PUCCH feedback to a base station for at least one SPS configuration of the multiple SPS configurations, the feedback occasion located within a subsequent cycle, as described in connection with the indication 728 of FIG. 7. The indicating of the feedback occasion, at 910, may be performed by an indication component 1044 of the apparatus 1002 of FIG. 10.

In some examples, the UE may provide the indication for the feedback occasion with PUCCH HARQ feedback during a current cycle, as described in connection with the indications 614a, 614b, 614c of FIG. 6.

In some examples, the indication may indicate a portion of a cycle of the at least one SPS configuration. For example, the indication may indicate that the feedback occasion is located during a first portion of a cycle of the at least one SPS configuration (e.g., the first portion 618a of FIG. 6) or a second portion of the cycle of the at least one SPS configuration (e.g., the second portion 618b of FIG. 6).

At 912, the UE may transmit the SPS PUCCH feedback to the base station at the indicated feedback occasion, as described in connection with the HARQ feedback 734 of FIG. 7. The transmitting of the SPS PUCCH feedback, at 912, may be performed by a feedback component 1046 of the apparatus 1002 of FIG. 10.

In some examples, the UE may transmit SPS HARQ feedback to the base station via an uplink data channel, such as PUSCH.

In some examples, the UE may monitor for channel variations (e.g., at 902) based on downlink interference. For example, at 904, the UE may detect a downlink interference pattern related to the SPS signaling, as described in connection with 722 of FIG. 7. The detecting of the downlink interference pattern, at 904, may be performed by an interference pattern component 1048 of the apparatus 1002 of FIG. 10. In some examples, the UE may detect the downlink interference pattern based on CSI-RS received during a current cycle. In some examples, the UE may detect the downlink interference pattern based on PDSCH received during a current cycle. The UE may then select the feedback occasion (e.g., at 908) based on the detected downlink interference pattern.

In some examples, the UE may monitor for channel variations (e.g., at 902) based on non-regular traffic. For example, at 906, the UE may detect a non-regular traffic pattern, as described in connection 724 of FIG. 7. The detecting of the non-regular traffic pattern, at 906, may be performed by a non-regular traffic pattern component 1050 of the apparatus 1002 of FIG. 10. The UE may then select the feedback occasion (e.g., at 908) based on the detected non-regular traffic pattern.

FIG. 10 is a diagram 1000 illustrating an example of a hardware implementation for an apparatus 1002. The apparatus 1002 may be a UE, a component of a UE, or may implement UE functionality. In some aspects, the apparatus 1002 may include a cellular baseband processor 1004 (also referred to as a modem) coupled to a cellular RF transceiver 1022. In some aspects, the apparatus 1002 may further include one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, or a power supply 1018. The cellular baseband processor 1004 communicates through the cellular RF transceiver 1022 with the UE 104 and/or base station 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 350 and may include the memory 360 and/or at least one of the TX processor 368, the RX processor 356, and the controller/processor 359. In one configuration, the apparatus 1002 may be a modem chip and include just the cellular baseband processor 1004, and in another configuration, the apparatus 1002 may be the entire UE (e.g., see the UE 350 of FIG. 3) and include the additional modules of the apparatus 1002.

The communication manager 1032 includes a channel monitoring component 1040 that is configured to monitor channel variations for SPS signaling associated with multiple SPS configurations, for example, as described in connection with 802 of FIGS. 8 and/or 902 of FIG. 9.

The communication manager 1032 also includes a feedback occasion component 1042 that is configured to select a feedback occasion for providing SPS PUCCH feedback, for example, as described in connection with 908 of FIG. 9.

The communication manager 1032 also includes an indication component 1044 that is configured to indicate the feedback occasion for providing SPS PUCCH feedback to a base station for at least one SPS configuration, for example, as described in connection with 804 of FIGS. 8 and/or 910 of FIG. 9.

The communication manager 1032 also includes a feedback component 1046 that is configured to transmit the SPS PUCCH feedback to the base station at the indicated feedback occasion, for example, as described in connection with 912 of FIG. 9.

The communication manager 1032 also includes an interference pattern component 1048 that is configured to detect a downlink interference pattern related to the SPS signaling, for example, as described in connection with 904 of FIG. 9.

The communication manager 1032 also includes a non-regular traffic pattern component 1050 that is configured to detect a downlink interference pattern related to the SPS signaling, for example, as described in connection with 906 of FIG. 9.

The apparatus may include additional components that perform each of the blocks of the algorithm in the flowcharts of FIGS. 8 and/or 9. As such, each block in the flowcharts of FIGS. 8 and/or 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1002 may include a variety of components configured for various functions. In one configuration, the apparatus 1002, and in particular the cellular baseband processor 1004, includes means for performing any of the aspects of the methods of FIGS. 8 and/or 9. For example, the apparatus 1002 may include means for monitoring channel variations for SPS signaling associated with multiple SPS configurations and means for indicating a feedback occasion for providing SPS PUCCH feedback to a base station for at least one SPS configuration of the multiple SPS configurations, the feedback occasion located within a subsequent cycle. The apparatus 1002 may further include means for transmitting the SPS PUCCH feedback to the base station at the feedback occasion. The apparatus 1002 may further include means for transmitting SPS HARQ feedback to the base station via a PUSCH. The means may be one or more of the components of the apparatus 1002 configured to perform the functions recited by the means. As described supra, the apparatus 1002 may include the TX processor 368, the RX processor 356, and the controller/processor 359. As such, in one configuration, the means may be the TX processor 368, the RX processor 356, and the controller/processor 359 configured to perform the functions recited by the means.

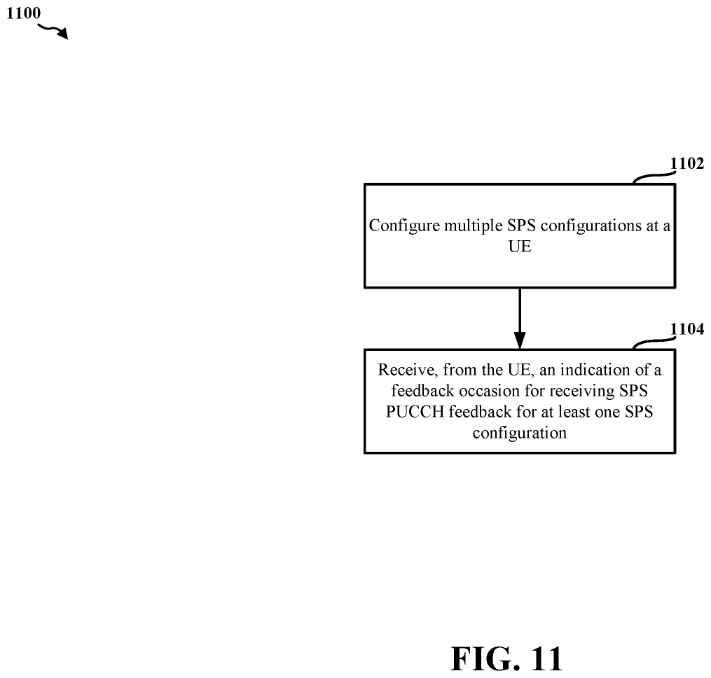

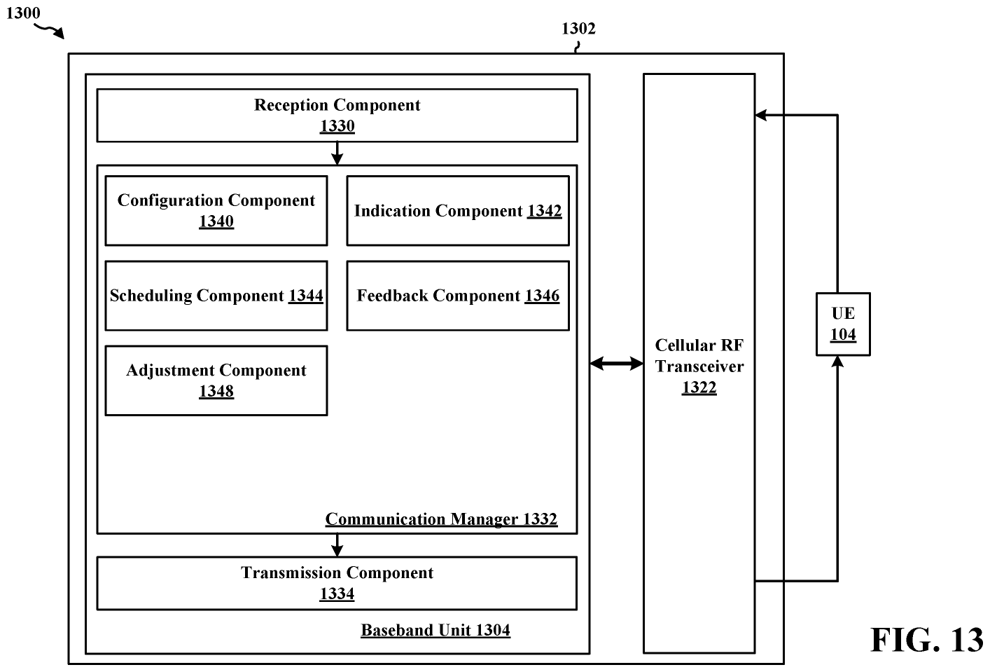

FIG. 11 is a flowchart 1100 of a method of wireless communication. The method may be performed by a base station (e.g., the base station 102/180, the base station 310, and/or an apparatus 1302 of FIG. 13). The method may facilitate reducing uplink overhead and/or reducing UE power consumption by enabling a UE to indicate to the base station a location of a single HARQ feedback for multiple SPS configurations.

At 1102, the base station configures multiple SPS configurations at a UE, as described in connection with 710 and the multiple SPS configurations 712 of FIG. 7. The configuring of the multiple SPS configurations, at 1102, may be performed by a configuration component 1340 of the apparatus 1302 of FIG. 13.

In some examples, each SPS configuration of the multiple SPS configurations may be offset from a preceding SPS configuration by a respective duration, such as the example duration 616 of FIG. 6.

At 1104, the base station receives, from the UE, an indication of a feedback occasion for receiving SPS PUCCH feedback for at least one SPS configuration of the multiple SPS configurations, the feedback occasion located within a subsequent cycle, as described in connection with the indication 728 of FIG. 7. The receiving of the indication of the feedback occasion, at 1104, may be performed by an indication component 1342 of the apparatus 1302 of FIG. 13.

In some examples, the base station may receive the indication for the feedback occasion with PUCCH HARQ feedback during a current cycle, as described in connection with the indications 614a, 614b, 614c of FIG. 6.

In some examples, the indication may indicate a portion of a cycle of the at least one SPS configuration. For example, the indication may indicate that the feedback occasion is located during a first portion of a cycle of the at least one SPS configuration (e.g., the first portion 618a of FIG. 6) or a second portion of the cycle of the at least one SPS configuration (e.g., the second portion 618b of FIG. 6).

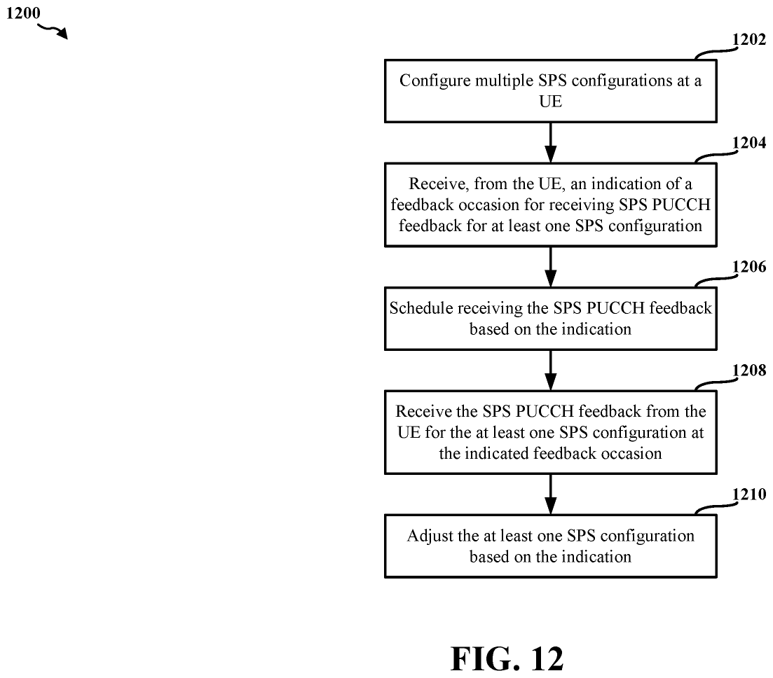

FIG. 12 is a flowchart 1200 of a method of wireless communication. The method may be performed by a base station (e.g., the base station 102/180, the base station 310, and/or an apparatus 1302 of FIG. 13). The method may facilitate reducing uplink overhead and/or reducing UE power consumption by enabling a UE to indicate to the base station a location of a single HARQ feedback for multiple SPS configurations.

At 1202, the base station configures multiple SPS configurations at a UE, as described in connection with 710 and the multiple SPS configurations 712 of FIG. 7. The configuring of the multiple SPS configurations, at 1202, may be performed by a configuration component 1340 of the apparatus 1302 of FIG. 13.

In some examples, each SPS configuration of the multiple SPS configurations may be offset from a preceding SPS configuration by a respective duration, such as the example duration 616 of FIG. 6.

At 1204, the base station receives, from the UE, an indication of a feedback occasion for receiving SPS PUCCH feedback for at least one SPS configuration of the multiple SPS configurations, the feedback occasion located within a subsequent cycle, as described in connection with the indication 728 of FIG. 7. The receiving of the indication of the feedback occasion, at 1204, may be performed by an indication component 1342 of the apparatus 1302 of FIG. 13.

In some examples, the base station may receive the indication for the feedback occasion with PUCCH HARQ feedback during a current cycle, as described in connection with the indications 614a, 614b, 614c of FIG. 6.

In some examples, the indication may indicate a portion of a cycle of the at least one SPS configuration. For example, the indication may indicate that the feedback occasion is located during a first portion of a cycle of the at least one SPS configuration (e.g., the first portion 618a of FIG. 6) or a second portion of the cycle of the at least one SPS configuration (e.g., the second portion 618b of FIG. 6).

At 1206, the base station may schedule receiving the SPS PUCCH feedback based on the indication, as described in connection with 730 of FIG. 7. The scheduling of the receiving of the SPS PUCCH feedback, at 1206, may be performed by a scheduling component 1344 of the apparatus 1302 of FIG. 13.

At 1208, the base station may receive the SPS PUCCH feedback from the UE for the at least one SPS configuration at the indicated feedback occasion, as described in connection with the HARQ feedback 734 of FIG. 7. The receiving of the SPS PUCCH feedback, at 1208, may be performed by a feedback component 1346 of the apparatus 1302 of FIG. 13.

In some examples, the base station may receive SPS HARQ feedback from the UE via an uplink data channel, such as PUSCH.

At 1210, the base station may adjust the at least one SPS configuration based on the indication, as described in connection with 732 of FIG. 7. The adjusting of the at least one SPS configuration, at 1210, may be performed by an adjustment component 1348 of the apparatus 1302 of FIG. 13.

FIG. 13 is a diagram 1300 illustrating an example of a hardware implementation for an apparatus 1302. The apparatus 1302 may be a base station, a component of a base station, or may implement base station functionality. In some aspects, the apparatus 1302 may include a baseband unit 1304. The baseband unit 1304 may communicate through a cellular RF transceiver 1322 with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the base station 310 and may include the memory 376 and/or at least one of the TX processor 316, the RX processor 370, and the controller/processor 375.

The communication manager 1332 includes a configuration component 1340 that is configured to configure multiple SPS configurations at a UE, for example, as described in connection with 1102 of FIGS. 11 and/or 1202 of FIG. 12.

The communication manager 1332 also includes an indication component 1342 that is configured to receive, from the UE, an indication of a feedback occasion for receiving SPS PUCCH feedback for at least one SPS configuration, for example, as described in connection with 1104 of FIGS. 11 and/or 1204 of FIG. 12.

The communication manager 1332 also includes a scheduling component 1344 that is configured to schedule receiving the SPS PUCCH feedback based on the indication, for example, as described in connection with 1206 of FIG. 12.

The communication manager 1332 also includes a feedback component 1346 that is configured to receive the SPS PUCCH feedback from the UE for the at least one SPS configuration at the indicated feedback occasion, for example, as described in connection with 1208 of FIG. 12.

The communication manager 1332 also includes an adjustment component 1348 that is configured to adjust the at least one SPS configuration based on the indication, for example, as described in connection with 1210 of FIG. 12.

The apparatus may include additional components that perform each of the blocks of the algorithm in the flowcharts of FIGS. 11 and/or 12. As such, each block in the flowcharts of FIGS. 11 and/or 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the baseband unit 1304, includes means for performing any of the aspects of the methods of FIGS. 11 and/or 12. For example, the apparatus 1302 may include means for configuring multiple SPS configurations at a UE and means for receiving, from the UE, an indication of a feedback occasion for receiving SPS PUCCH feedback for at least one SPS configuration of the multiple SPS configurations, the feedback occasion located within a subsequent cycle. The apparatus 1302 may include means for scheduling receiving the SPS PUCCH feedback based on the indication. The apparatus 1302 may include means for adjusting the at least one SPS configuration based on the indication. The apparatus 1302 may include means for receiving the SPS PUCCH feedback from the UE for the at least one SPS configuration at the feedback occasion. The apparatus 1302 may include means for receiving HARQ feedback from the UE via a PUSCH. The means may be one or more of the components of the apparatus 1302 configured to perform the functions recited by the means. As described supra, the apparatus 1302 may include the TX processor 316, the RX processor 370, and the controller/processor 375. As such, in one configuration, the means may be the TX processor 316, the RX processor 370, and the controller/processor 375 configured to perform the functions recited by the means.

The aspects presented herein may enable a UE to indicate feedback occasions for providing HARQ feedback, which may facilitate improving communication performance, for example, by reducing uplink overhead.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a UE, comprising: monitoring channel variations for SPS signaling associated with multiple SPS configurations; and indicating a feedback occasion for providing SPS PUCCH feedback to a base station for at least one SPS configuration of the multiple SPS configurations, the feedback occasion located within a subsequent cycle.

In aspect 2, the method of aspect 1 further includes that the UE monitors the channel variations by detecting a downlink interference pattern related to the SPS signaling and selects the feedback occasion for providing the SPS PUCCH feedback based on the downlink interference pattern.

In aspect 3, the method of aspect 2 further includes that the UE detects the downlink interference pattern based on at least one of received CSI-RS and received PDSCH during a current cycle.

In aspect 4, the method of aspect 1 further includes that the UE monitors the channel variations by detecting a non-regular traffic pattern and selects the feedback occasion for providing the SPS PUCCH feedback based on the non-regular traffic pattern.

In aspect 5, the method of any of aspects 1-4 further includes that the UE provides the feedback occasion with PUCCH HARQ feedback during a current cycle.

In aspect 6, the method of any of aspects 1-5 further includes that indicating the feedback occasion indicates a portion of a cycle of the at least one SPS configuration.

In aspect 7, the method of any of aspects 1-6 further includes that each SPS configuration of the multiple SPS configurations is offset from a preceding SPS configuration by a respective duration.

In aspect 8, the method of any of aspects 1-7 further includes that comprising transmitting the SPS PUCCH feedback to the base station at the feedback occasion.

In aspect 9, the method of any of aspects 1-4, 6, or 7 further includes transmitting SPS HARQ feedback to the base station via a PUSCH.

Aspect 10 is an apparatus for wireless communication at a UE, comprising means to perform the method of any of aspects 1-9.

In aspect 11, the apparatus of aspect 10 further includes at least one antenna and a transceiver coupled to the at least one antenna and the means to perform the method of any of aspects 1-9.

Aspect 12 is an apparatus for wireless communication at a UE, comprising a memory and at least one processor coupled to the memory and configured to perform the method of any of aspects 1-9.

In aspect 13, the apparatus of aspect 12 further includes at least one antenna and a transceiver coupled to the at least one antenna and the at least one processor.

Aspect 14 is a non-transitory computer-readable medium storing computer executable code for wireless communication at a UE, where the code when executed by a processor causes the processor to implement the method of any of aspects 1-9.

Aspect 15 is a method of wireless communication at a base station, comprising: configuring multiple SPS configurations at a UE; and receiving, from the UE, an indication of a feedback occasion for receiving SPS PUCCH feedback for at least one SPS configuration of the multiple SPS configurations, the feedback occasion located within a subsequent cycle.

In aspect 16, the method of aspect 15 further includes scheduling receiving the SPS PUCCH feedback based on the indication.

In aspect 17, the method of aspect 15 or aspect 16 further includes that the base station adjusts the at least one SPS configuration based on the indication.

In aspect 18, the method of any of aspects 15-17 further includes that the base station receives the indication for the feedback occasion with PUCCH HARQ feedback during a current cycle.

In aspect 19, the method of any of aspects 15-18 further includes that the indication indicates a portion of a cycle of the at least one SPS configuration.

In aspect 20, the method of any of aspects 15-19 further includes that the base station offsets each SPS configuration of the multiple SPS configurations from a preceding SPS configuration by a respective duration.

In aspect 21, the method of any of aspects 15-20 further includes receiving the SPS PUCCH feedback from the UE for the at least one SPS configuration at the feedback occasion.

In aspect 22, the method of any of aspects 15-20 further includes receiving HARQ feedback from the UE via a PUSCH.

Aspect 23 is an apparatus for wireless communication at a base station, comprising means to perform the method of any of aspects 15-22.

In aspect 24, the apparatus of aspect 23 further includes at least one antenna and a transceiver coupled to the at least one antenna and the means to perform the method of any of aspects 15-22.

Aspect 25 is an apparatus for wireless communication at a base station, comprising a memory and at least one processor coupled to the memory and configured to perform the method of any of aspects 15-22.

In aspect 26, the apparatus of aspect 25 further includes at least one antenna and a transceiver coupled to the at least one antenna and the at least one processor.

Aspect 27 is a non-transitory computer-readable medium storing computer executable code for wireless communication at a base station, where the code when executed by a processor causes the processor to implement the method of any of aspects 15-22

What is claimed is:

1. An apparatus of wireless communication at a user equipment (UE), comprising:
memory; and
at least one processor coupled to the memory, the memory and the at least one processor configured to:
monitor channel variations for semi-persistent scheduling (SPS) signaling associated with multiple SPS configurations; and
indicate a feedback occasion for providing SPS physical uplink control channel (PUCCH) feedback to a base station for at least one SPS configuration of the multiple SPS configurations, the feedback occasion located within a subsequent cycle.

2. The apparatus of claim 1, wherein the memory and the at least one processor are configured to monitor the channel variations by detecting a downlink interference pattern related to the SPS signaling and select the feedback occasion for providing the SPS PUCCH feedback based on the downlink interference pattern.

3. The apparatus of claim 2, wherein the memory and the at least one processor are configured to detect the downlink interference pattern based on at least one of received channel state information reference signals (CSI-RS) and received physical downlink shared channel (PDSCH) during a current cycle.

4. The apparatus of claim 1, wherein the memory and the at least one processor are configured to monitor the channel variations by detection of a non-regular traffic pattern and to select the feedback occasion for providing the SPS PUCCH feedback based on the non-regular traffic pattern.

5. The apparatus of claim 1, wherein the memory and the at least one processor are configured to provide the feedback occasion with PUCCH hybrid automatic repeat request (HARD) feedback during a current cycle.

6. The apparatus of claim 1, wherein to indicate the feedback occasion the memory and the at least one processor are configured to indicate a portion of a cycle of the at least one SPS configuration.

7. The apparatus of claim 1, wherein each SPS configuration of the multiple SPS configurations is offset from a preceding SPS configuration by a respective duration.

8. The apparatus of claim 1, wherein the memory and the at least one processor are further configured to:
transmit the SPS PUCCH feedback to the base station at the feedback occasion, or
transmit SPS hybrid automatic repeat request (HARD) feedback to the base station via a physical uplink shared channel (PUSCH).

9. The apparatus of claim 1, further comprising:
at least one antenna; and
a transceiver coupled to the at least one antenna and the at least one processor.

10. A method of wireless communication at a user equipment (UE), comprising:
monitoring channel variations for semi-persistent scheduling (SPS) signaling associated with multiple SPS configurations; and
indicating a feedback occasion for providing SPS physical uplink control channel (PUCCH) feedback to a base station for at least one SPS configuration of the multiple SPS configurations, the feedback occasion located within a subsequent cycle.

11. The method of claim 10, wherein the UE monitors the channel variations by detecting a downlink interference pattern related to the SPS signaling and selects the feedback occasion for providing the SPS PUCCH feedback based on the downlink interference pattern.

12. The method of claim 11, wherein the UE detects the downlink interference pattern based on at least one of received channel state information reference signals (CSI-RS) and received physical downlink shared channel (PDSCH) during a current cycle.

13. The method of claim 10, wherein the UE monitors the channel variations by detecting a non-regular traffic pattern and selects the feedback occasion for providing the SPS PUCCH feedback based on the non-regular traffic pattern.

14. The method of claim 10, wherein the UE provides the feedback occasion with PUCCH hybrid automatic repeat request (HARQ) feedback during a current cycle.

15. The method of claim 10, wherein indicating the feedback occasion indicates a portion of a cycle of the at least one SPS configuration.

16. The method of claim 10, wherein each SPS configuration of the multiple SPS configurations is offset from a preceding SPS configuration by a respective duration.

17. The method of claim 10, further comprising transmitting the SPS PUCCH feedback to the base station at the feedback occasion or transmitting SPS hybrid automatic repeat request (HARQ) feedback to the base station via a physical uplink shared channel (PUSCH).

18. An apparatus for wireless communication at a base station, comprising:
memory; and
at least one processor coupled to the memory, the memory and the at least one processor configured to:
configure multiple semi-persistent scheduling (SPS) configurations at a user equipment (UE); and
receive, from the UE, an indication of a feedback occasion for receiving SPS physical uplink control channel (PUCCH) feedback for at least one SPS configuration of the multiple SPS configurations, the feedback occasion located within a subsequent cycle.

19. The apparatus of claim 18, wherein the memory and the at least one processor are further configured to:
schedule reception of the SPS PUCCH feedback based on the indication.

20. The apparatus of claim 18, wherein the memory and the at least one processor are configured to adjust the at least one SPS configuration based on the indication.

21. The apparatus of claim 18, wherein the memory and the at least one processor are configured to receive the indication for the feedback occasion with PUCCH hybrid automatic repeat request (HARQ) feedback during a current cycle.

22. The apparatus of claim 18, wherein the indication indicates a portion of a cycle of the at least one SPS configuration.

23. The apparatus of claim 18, wherein the memory and the at least one processor are configured to offset each SPS configuration of the multiple SPS configurations from a preceding SPS configuration by a respective duration.

24. The apparatus of claim 18, wherein the memory and the at least one processor is further configured to:
receive the SPS PUCCH feedback from the UE for the at least one SPS configuration at the feedback occasion, or
receive hybrid automatic repeat request (HARQ) feedback from the UE via a physical uplink shared channel (PUSCH).

25. The apparatus of claim 18, further comprising:
at least one antenna; and
a transceiver coupled to the at least one antenna and the at least one processor.

26. A method of wireless communication at a base station, comprising:
configuring multiple semi-persistent scheduling (SPS) configurations at a user equipment (UE); and
receiving, from the UE, an indication of a feedback occasion for receiving SPS physical uplink control channel (PUCCH) feedback for at least one SPS configuration of the multiple SPS configurations, the feedback occasion located within a subsequent cycle.

27. The method of claim 26, further comprising:
scheduling reception the SPS PUCCH feedback based on the indication.

28. The method of claim 26, wherein the base station adjusts the at least one SPS configuration based on the indication.

29. The method of claim 26, wherein the base station receives the indication for the feedback occasion with PUCCH hybrid automatic repeat request (HARQ) feedback during a current cycle.

30. The method of claim 26, further comprising:
receiving the SPS PUCCH feedback from the UE for the at least one SPS configuration at the feedback occasion, or
receiving hybrid automatic repeat request (HARQ) feedback from the UE via a physical uplink shared channel (PUSCH).
